(19) United States
(12) Patent Application Publication
(10) Pub. No.: US 2009/0286635 A1
(43) Pub. Date: Nov. 19, 2009

(54) Tension regulating apparatus for chain of leftover food treating device

(76) Inventors: Bok Gyeong KIM, Suwon-si (KR); Jin Hyun SHON, Seongnam-si (KR); Yun Jong Kim, Seoul (KR)

Correspondence Address: MCDERMOTT WILL & EMERY LLP, 600 13TH STREET, N.W., WASHINGTON, DC, 20005-3096, US

(21) Appl. No.: 12/153,190

(22) Filed: May 15, 2008

(51) Int. Cl. F16H 7/14

(52) U.S. Cl. 474/101

(57) ABSTRACT

The present invention provides a tension regulating apparatus for a chain of a leftover food treating device which comprises an agitation shaft having agitation blades and rotatably installed in an agitation tank and a rotation unit installed on one side of the agitation shaft for providing the agitation shaft with a rotational force, the tension regulating apparatus comprising: a driving sprocket engaged with a driving shaft of a driving motor provided on one side of the agitation tank; a driven sprocket connected to the driving sprocket by a connecting chain and engaged with one end of the agitation shaft; and a tension sprocket provided between the driving sprocket and the driven sprocket, for regulating the tension of the connecting chain. According to the present invention, the tension of the connecting chain connecting the driving sprocket and the driven sprocket can be regulated properly by the tension sprocket installed between the driving sprocket and the driven sprocket, in order to improve the engagement state between the connecting chain and the sprockets, thereby smoothly rotating the agitation shaft and minimizing the noise

### BACKGROUND OF THE INVENTION

1. Field of the Invention

The present invention relates to a leftover food treating device, and more particularly to a tension regulating apparatus for a chain of a leftover food treating device which can provide a proper rotational force to an agitation shaft for agitating leftover food introduced into the agitation tank when the leftover food is treated.

2. Description of the Prior Art

Generally, homes or food restaurants generate a large amount of leftover food (wasted food) everyday. Some of the leftover food is used as feeds of domestic animals, but due to the difficulty in carrying and treating the leftover food, almost all the leftover food is reclaimed or incinerated.

However, in the former reclamation method, bad smells are generated by nitrogen and sulfur compounds. Further, the atmosphere, the water, the soil, and the underground water are seriously contaminated by the high density leachate and the like.

On the other hand, the latter incineration method requires incinerators of high capacities, contaminates the atmospheric environment due to harmful substances discharged into the air during the incineration. Further, the incinerating efficiency of leftover food is lowered by the low-caloric leftover food itself and by the moisture in the leftover food. Therefore, the incineration method is so uneconomical that it costs a lot of expenses to treat the leftover food. Further, harmful substances such as dioxin can be discharged from the leftover food due to the incomplete combustion of the leftover food.

Therefore, recently, various leftover food treating devices have been installed and used in food restaurants and at homes in order to treat leftover food by themselves. Among them, an incineration method and a fermentation method using microorganisms are mainly used to treat leftover food.

A currently developed incineration-type treating device, which directly heats leftover food, requires a lot of treating expenses if a large amount of moisture is contained in the leftover food. Further, it causes secondary pollution factors such as smoke and smell during incineration of the leftover food. Therefore, it has not been widely used till now.

On the other hand, various fermentation-type treating devices have been developed and circulated. According to the devices, microorganisms which can decompose leftover food are introduced into a reaction tank together with the leftover food and the conditions in the interior of the reaction tank, such as temperature and humidity, are controlled in such a manner that the leftover food can be decomposed and the volume of the leftover food can be reduced.

Such a fermentation-type treating device generally includes agitation blades for agitating the leftover food in an agitation tank into which the leftover food is introduced. The agitation blades cross the agitation tank transversely and are engaged with an agitation shaft in such a manner that they can be rotated with a predetermined radius.

Further, a rotation unit for rotating the agitation shaft at a predetermined speed is provided on one side of the agitation shaft. The rotation unit includes a driving motor for generating a rotational force, a driving sprocket engaged with a driving shaft of the driving motor, and a driven sprocket connected to the driving sprocket by a connecting chain and engaged with one end of the agitation shaft to transfer a driving force.

However, in a conventional fermentation-type treating device, the tension of the connecting chain connecting the driven sprocket to the driving sprocket for rotating the agitation shaft cannot be properly regulated, thereby hindering smooth rotation of the agitation shaft.

Accordingly, if the connecting chain and the driven sprocket are not properly geared, the agitation shaft is idled, thereby generating noises.

### SUMMARY OF THE INVENTION

Accordingly, the present invention has been made to solve the above-mentioned problems occurring in the prior art, and an object of the present invention is to provide a tension regulating apparatus for a chain of a leftover food treating device, which can properly regulate the tension of a connecting chain connecting a driven sprocket to a driving sprocket so that an agitation shaft can be smoothly rotated.

In order to accomplish this object, according to a preferred embodiment of the present invention, there is provided a tension regulating apparatus for a chain of a leftover food treating device which comprises an agitation shaft having agitation blades and rotatably installed in an agitation tank and a rotation unit installed on one side of the agitation shaft for providing the agitation shaft with a rotational force, the tension regulating apparatus comprising: a driving sprocket engaged with a driving shaft of a driving motor provided on one side of the agitation tank; a driven sprocket connected to the driving sprocket by a connecting chain and engaged with one end of the agitation shaft; and a tension sprocket provided between the driving sprocket and the driven sprocket, for regulating the tension of the connecting chain.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view for showing the appearance of a leftover food treating device according to the present invention;

FIG. 2 is a partially cutaway perspective view for showing a leftover food treating device according to the present invention;

FIG. 3 is a cross-sectional view for showing a preferred embodiment of a leftover food treating device according to the present invention;

FIG. 4 is a cross-sectional view for showing another preferred embodiment of a leftover food treating device according to the present invention; and

FIG. 5 is a cross-sectional view for showing a preferred embodiment of a leftover food treating device according to the present invention.

### DETAILED DESCRIPTION OF THE PREFERRED EMBODIMENTS

Hereinafter, preferred embodiments of a tension regulating apparatus for a chain of a leftover food treating device according to the present invention will be described with reference to the accompanying drawings.

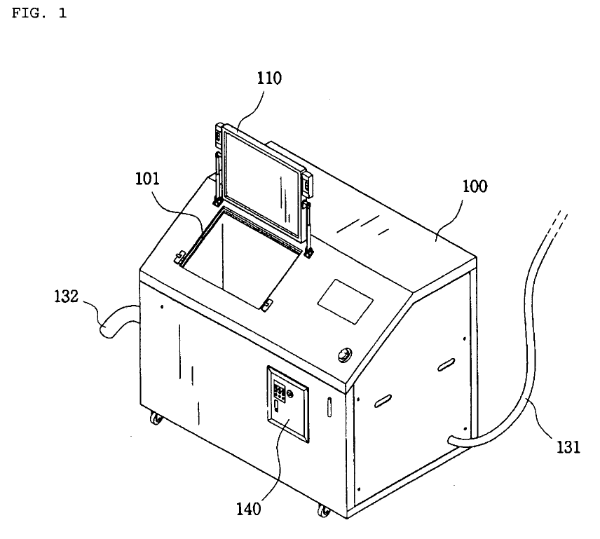

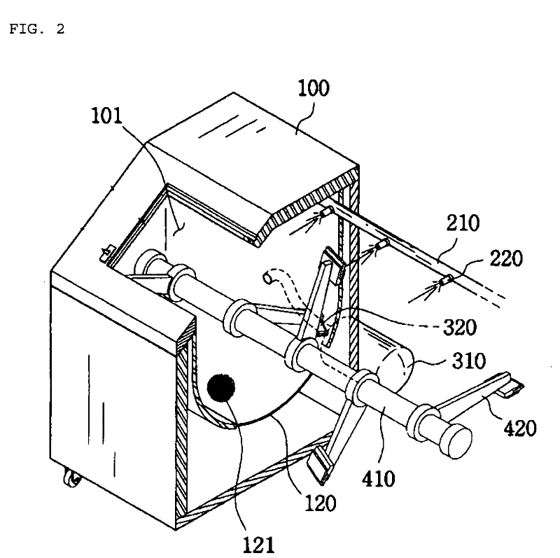

First, a leftover food treating device according to the present invention will be described briefly. As shown in FIGS. 1 and 2, the leftover food treating device has a body 100 in which an introduction opening 101 for introducing leftover food is formed on the upper surface thereof. A cover 110 is engaged with one side of the introduction opening 101 in such a manner that it can open or close the introduction opening 101.

A control unit 140 for operating and controlling the leftover food treating device when leftover food is treated is provided on one side of the front surface of the body 100.

The cover 110 is engaged with the introduction opening 101 of the body 100 in such a manner that it can open or close the introduction opening 101, and seals the interior of the body 100 while the leftover food introduced into an agitation tank 120 is being treated.

On the other hand, as shown in FIG. 2, the agitation tank 120 having a predetermined capacity for cultivating microorganisms and treating leftover food is provided in the middle of the interior of the body 100. A discharging portion 121 in which a plurality of discharging holes are formed to discharge the moisture generated while treating the leftover food is mounted to the bottom of the agitation tank 120.

A water dropping portion 130 for temporarily storing and discharging the fluid, which is decomposed and liquefied by the microorganisms and which is dropped from the discharging portion 121, is provided on the lower side of the agitation tank 120.

A water supply pipe 210 is transversely engaged with the upper end of the agitation tank 120. A plurality of injection nozzles 220 are installed in the water supply pipe 210 and are separated from one another by a predetermined interval. Therefore, if leftover food is introduced into the agitation tank 120, water is injected into the agitation tank 120 through the water supply pipe 210 in order to provide the interior of the agitation tank 120 with the humidity suitable for cultivation of microorganisms.

An oxygen supply opening is provided on one side of the agitation tank 120. An oxygen supply pipe 320 is connected to the oxygen supply opening so that the oxygen generated by the operation of an air compressor 310 can be supplied into the agitation tank 120. Therefore, the oxygen supplied into the agitation tank 120 optimizes the activation of microorganisms.

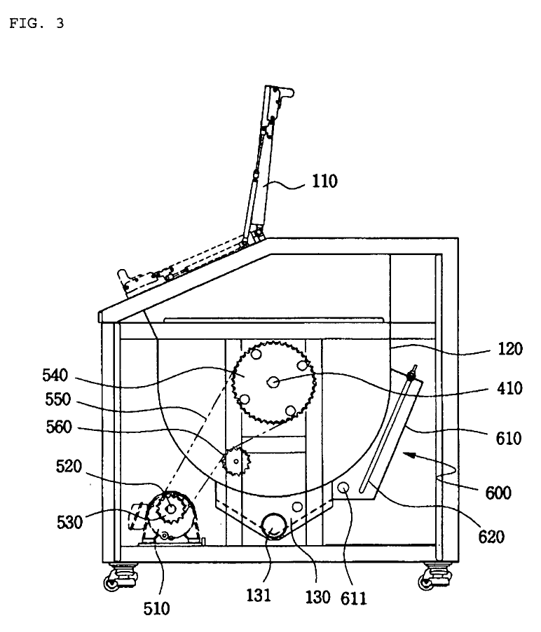

On the other hand, as shown in FIGS. 2 and 3, an agitation shaft 410 is rotatably and transversely engaged with the agitation tank 120, and agitation blades 420 for agitating and decomposing the leftover food introduced into the agitation tank 120 are engaged with the agitation shaft 410 so as to be perpendicular to the agitation shaft 410.

The tip end of the agitation shaft 410 penetrates outside the agitation tank 120. Further, a driven sprocket 540 is engaged with the tip end of the agitation shaft 410. The driven sprocket 540 is connected to a driving sprocket 530 by a connecting chain 550. The driven sprocket 540 is rotated in connection with the rotation of the driving shaft 530, which is rotated by a driving force of a driving motor 510.

Therefore, if electric power is applied to the driving motor 510 to operate the driving motor 510, the driving sprocket 530 engaged with the driving shaft 520 is rotated in one direction and the driven sprocket 540 connected to the driving sprocket 530 by the connecting chain 550 is rotated together with the driving sprocket 530. Accordingly, the agitation shaft 410 one end of which is engaged with the driven sprocket 540 is rotated so that the agitation blades 420 can agitate the leftover food introduced into the agitation tank 120.

Then, according to the first preferred embodiment of the present invention, a tension sprocket 560 is provided between the driving sprocket 530 and the driven sprocket 540. Therefore, the tension sprocket 560 is engaged with the connecting chain 550 together with the driving sprocket 530 and the driven sprocket 540 in order to regulate the tension of the connecting chain 550 provided between the driving sprocket 530 and the driven sprocket 540, which can be loosened.

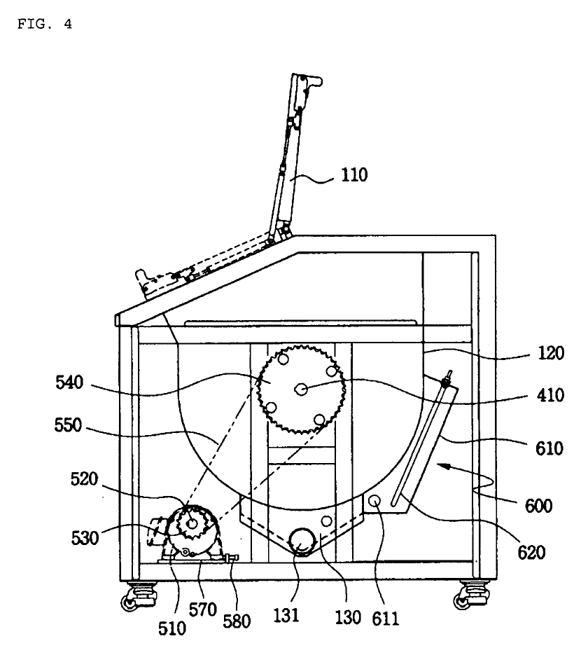

FIG. 4 shows the second preferred embodiment of the present invention. In the second preferred embodiment, the driving motor 510 is installed on the upper surface of a support frame 570 provided on the bottom surface of the body 100. Namely, the support frame 570 functions as a support on which the driving motor 510 positioned on the upper surface thereof can be moved.

A tension regulating bolt 580 is engaged with one side of the support frame 570 in such a manner that the position of the driving motor 510 can be regulated by moving the driving motor 510 in parallel by a predetermined distance.

Therefore, since the installation position of the driving motor 510 located on the support frame 570 can be changed by regulating the tension regulating bolt 580, if the connecting chain 550 connecting the driven sprocket 540 to the driving sprocket 530 is loosened, the tension regulating bolt 580 is rotated in one direction so that the driving motor 510 is far away from the driven sprocket 540, in order to regulate the tension of the connecting chain 550. Further, in the contrary case, the tension regulating bolt 580 is rotated in the other direction so that the driving motor 510 is closer to the driven sprocket 540, in order to regulate the tension of the connecting chain 550.

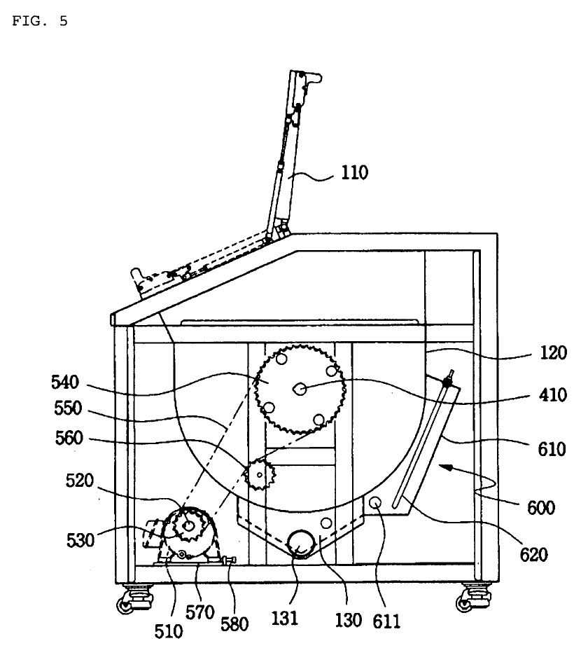

FIG. 5 shows the third preferred embodiment of the present invention. In the third preferred embodiment, the present invention applies the first and second preferred embodiments together.

In other words, the tension sprocket 560 is installed at one end of the connecting chain 550 connecting the driven sprocket 540 to the driving sprocket 530. Further, the support frame 570 supporting the driving motor 510 is provided on the bottom surface of the driving motor 510, and the tension regulating bolt 580 for regulating the position of the driving motor 510 is engaged with one side of the support frame 570.

Therefore, as compared with the first and second preferred embodiments, the third preferred embodiment can regulate the tension of the connecting chain 550 more easily and more stably.

In FIGS. 1 to 5, the reference numeral 130 represents a water supplying hose, and the reference numeral 132 represents a water discharging hose. Further, the reference numeral 600 represents a temperature regulating apparatus which maintain the temperature in the interior of the agitation tank 120 properly so as to optimize the activation of microorganisms cultivated in the agitation tank 120. The temperature regulating apparatus 600 includes a hot water tank 610 mounted on the rear side of the agitation tank 40 and a heater 620 installed in the interior of the hot water tank 610.

Hereinafter, the operation of the leftover food treating device according to the present invention will be described in detail.

In the state in which microorganisms are cultivated in the agitation tank 120, after a predetermined amount of leftover food is introduced into the agitation tank 120, the cover 110 provided at an upper portion of the body 100 is shut to close the interior of the body 100.

Thereafter, if electric power is applied to the leftover food treating device by operating the control unit 140 provided on the front surface of the body 100, oxygen is introduced into the agitation tank 120 through the oxygen supply pipe 320 of the agitation tank 120 by the operation of the air compressor 310 so that the microorganisms can be actively cultivated. Further, water is sprayed through a plurality of injection nozzles 220 to provide the agitation tank 120 with the humidity most suitable for the activation of the microorganisms.

At the same time, as the electric power is applied to the driving motor 510, the driving motor 510 is rotated and the driving sprocket 530 and the driven sprocket 540 are rotated together by means of the connecting chain 550. Further, the agitation shaft 410 connected to the driven sprocket 540 is rotated together with the driven sprocket 540. Then, the connecting chain 550 is properly engaged with the driving sprocket 530 and the driven sprocket 540 by the tension sprocket 560 and the tension regulating bolt 580. Therefore, the noise which is generated while operating the leftover food treating device can be minimized.

In this way, if the agitation shaft 410 connected to the drive unit is rotated for a predetermined period of time so that the agitation blades 420 agitate the leftover food, the microorganisms cultivated in the agitation tank 120 are properly mixed with the agitated leftover food. Then, the agitated leftover food is changed into water and carbon dioxide by the biochemical reaction of the microorganisms. Thereafter, the treatment of the leftover food is completed by discharging the water generated by the biochemical reaction and the moisture contained in the leftover food through the discharging portion 121.

In other words, as the leftover food is continuously agitated and decomposed in the agitation tank 120 for a predetermined period of time, it is changed into water and carbon dioxide. The leftover food treating process is completed as the moisture is discharged through the discharging portion 121.

According to the present invention, the tension of the connecting chain connecting the driven sprocket to the driving sprocket can be regulated properly by the tension sprocket installed between the driving sprocket and the driven sprocket, in order to improve the engagement state between the connecting chain and the sprockets, thereby smoothly rotating the agitation shaft and minimizing the noise.

Although preferred embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A tension regulating apparatus for a chain of a leftover food treating device which comprises an agitation shaft having agitation blades and rotatably installed in an agitation tank and a rotation unit installed on one side of the agitation shaft for providing the agitation shaft with a rotational force, the tension regulating apparatus comprising:
a driving sprocket engaged with a driving shaft of a driving motor provided on one side of the agitation tank;
a driven sprocket connected to the driving sprocket by a connecting chain and engaged with one end of the agitation shaft; and
a tension sprocket provided between the driving sprocket and the driven sprocket, for regulating the tension of the connecting chain.

2. A tension regulating apparatus according to claim 1, wherein a support frame for supporting horizontal movement of the driving motor is provided on the bottom surface of the driving motor and a tension regulating bolt for regulating a position of the driving motor is engaged with one side of the support frame.
